(19) United States
(12) Patent Application Publication
(10) Pub. No.: US 2006/0224595 A1
(43) Pub. Date: Oct. 5, 2006

(54) Data management apparatus, data management method, and data management program

(75) Inventors: Yasuo Nakayashiki, Kawasaki (JP); Iwao Miura, Oyama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/167,295

(22) Filed: Jun. 28, 2005

(30) Foreign Application Priority Data
Mar. 30, 2005 (JP) 2005-989946

(51) Int. Cl. G06F 17/30

(52) U.S. Cl. 707/10

(57) ABSTRACT

A data management apparatus comprises a data registration section that registers data in a plurality of different databases storing data related to a common management target, and a data association section that associates first data registered in one of the plurality of databases with second data, the second data being registered in a database other than the database that stores the first data, being related to the same management target with the first data, and having a predetermined correspondence with the first data, wherein the predetermined correspondence is a relation in which one data is derived from the other data.

### BACKGROUND OF THE INVENTION

1. Field of the Invention

The present invention relates to management of a plurality of different databases for storing data related to a common management target.

2. Description of the Related Art

A technique for performing management of data registered in a plurality of different databases, initial registration of the data, and change (update) of the registered contents related to the data has been proposed (refer to, for example, Jpn. Pat. Appln. Laid-Open Publication No. 2002-73708 (pages 5 to 11, FIG. 1), No. 2001-195295 (pages 5 to 6, FIG. 1), No. 2001-76044 (pages 3 to 6, FIG. 2), and No. 10-187859 (pages 7 to 11, FIG. 3)).

The above prior arts have a configuration in which data registered in one database and data registered in another database are associated with each other based on an item (e.g., “ID” by which data are classified in the databases) defined in common between the databases.

However, the data association based only on the item defined in common between a plurality of databases performed in the prior arts does not always perform data collaboration between the databases satisfactorily. The inadequate data collaboration between a plurality of databases prevents a reduction in burden on a manager who manages the databases, in some cases.

### SUMMARY OF THE INVENTION

The present invention has been made to solve the above problem, and an object thereof is to provide a technique that can contribute to a reduction in management burden in the case where a plurality of databases are managed.

To solve the above problem, according to a first aspect of the present invention, there is provided a data management apparatus comprising: a data registration section that registers data in a plurality of different databases storing data related to a common management target; and a data association section that associates first data registered in one of the plurality of databases with second data, the second data being registered in a database other than the database that stores the first data, being related to the same management target with the first data, and having a predetermined correspondence with the first data, wherein the predetermined correspondence is a relation in which one data is derived from the other data.

It is preferable that the above data management apparatus comprise a notification section that performs a predetermined notification to a user having authority to permit or forbid a data registration or update registration when the data registration or update registration is performed by the data registration section, when a predetermined answer related to the permission or forbiddance is not returned from a first user even after a predetermined time has elapsed since the predetermined notification was performed, the notification section performing the predetermined notification to a second user having the same level of authority or having the authority to conduct a process to be performed next to the process to be performed based on the authority of the first user, if exists.

In the above data management apparatus, the notification section can perform a predetermined notification to a predetermined address at a predetermined timing after the data registration or data update registration has been performed by the data registration section.

The above data management apparatus comprises an information generation section that generates information based on data to be newly registered or registered for update when the data registration or update registration is performed by the data registration section.

It is preferable in the above data management apparatus that the notification section perform a predetermined notification in the case where data registration or update registration performed by the data registration section causes a contradiction in a predetermined correspondence between first data to be newly registered or registered for update with second data, the second data being stored in a database other than the database that the first data is to be registered in and being related to the same management target with the first data.

In the above data management apparatus, the plurality of databases can constitute a relational database.

According to a second aspect of the present invention, there is provided a data management method comprising: a data registration step that registers data in a plurality of different databases storing data related to a common management target; and a data association step that associates first data registered in one of the plurality of databases with second data, the second data being registered in a database other than the database that stores the first data, being related to the same management target with the first data, and having a predetermined correspondence with the first data, wherein the predetermined correspondence is a relation in which one data is derived from the other data.

The above data management method comprises a notification step that performs a predetermined notification to a user having authority to permit or forbid a data registration or update registration when the data registration or update registration is performed in the data registration step. When a predetermined answer related to the permission or forbiddance is not returned from a first user even after a predetermined time has elapsed since the predetermined notification was performed, the notification step performs a notification to a second user having the same level of authority or having the authority to conduct a process to be performed next to the process to be performed based on the authority of the first user, if exists.

In the above data management method, it is preferable that the notification step perform a predetermined notification to a predetermined address at a predetermined timing after the data registration or data update registration has been performed in the data registration step.

The above data management method can comprise an information generation step that generates information based on data to be newly registered or registered for update when the data registration or update registration is performed in the data registration step.

In the above data management method, the notification step can perform a predetermined notification in the case where data registration or update registration performed in the data registration step causes a contradiction in a predetermined correspondence between first data to be newly registered or registered for update with second data, the second data being stored in a database other than the database that the first data is to be registered in and being related to the same management target with the first data.

In the above data management method, the plurality of databases can constitute a relational database.

According to a third aspect of the present invention, there is provided a data management program allowing a computer to execute: a data registration step that registers data in a plurality of different databases storing data related to a common management target; and a data association step that associates first data registered in one of the plurality of databases with second data, the second data being registered in a database other than the database that stores the first data, being related to the same management target with the first data, and having a predetermined correspondence with the first data, wherein the predetermined correspondence is a relation in which one data is derived from the other data.

It is preferable that the above data management program comprise a notification step that performs a predetermined notification to a user having authority to permit or forbid a data registration or update registration when the data registration or update registration is performed in the data registration step, when a predetermined answer related to the permission or forbiddance is not returned from a first user even after a predetermined time has elapsed since the predetermined notification was performed, the notification step performing the predetermined notification to a second user having the same level of authority or having the authority to conduct a process to be performed next to the process to be performed based on the authority of the first user, if exists.

In the above data management program, the notification step can perform a predetermined notification to a predetermined address at a predetermined timing after the data registration or data update registration has been performed by the data registration step.

It is preferable that the above data management program comprise an information generation step that generates information based on data to be newly registered or registered for update when the data registration or update registration is performed in the data registration step.

In the above data management program, the notification step can perform a predetermined notification in the case where data registration or update registration performed in the data registration step causes a contradiction in a predetermined correspondence between first data to be newly registered or registered for update with second data, the second data being stored in a database other than the database that the first data is to be registered in and being related to the same management target with the first data.

It is preferable in the above data management program that the plurality of databases constitute a relational database.

As described above in detail, according to the present invention, it is possible to provide a technique that can contribute to a reduction in management burden in the case where a plurality of databases are managed.

### BRIEF DESCRIPTION OF THE DRAWINGS

FIG. 1 is a configuration diagram for explaining a data management apparatus according to an embodiment of the present invention;

FIG. 2 is a view for explaining an example of management of data registered in databases utilizing the data management apparatus according the embodiment of the present invention;

FIG. 3 is a flowchart for explaining the process flow (data management method) in the data management apparatus according to the embodiment of the present invention;

FIG. 4 is a view for explaining the flow of a data registration process and data update process for databases; and

FIG. 5 is a view for explaining a search process for data registered in databases 201 to 205 in the database management apparatus according to the embodiment of the present invention.

### DETAILED DESCRIPTION OF THE PREFERRED EMBODIMENTS

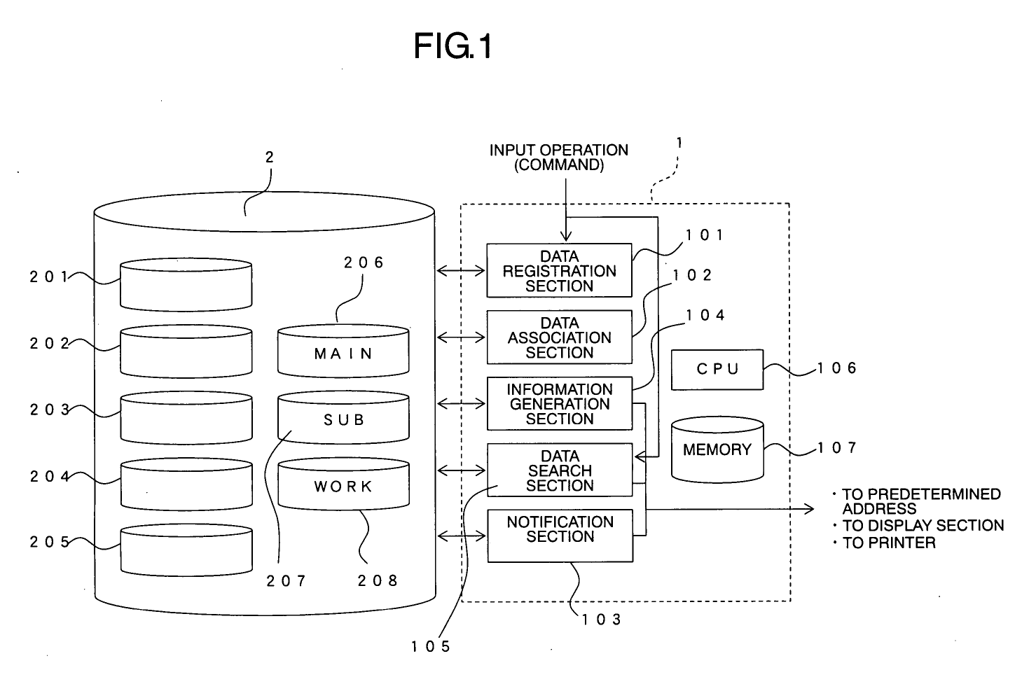

An embodiment of the present invention will be described below with reference to the accompanying drawings. FIG. 1 is a configuration diagram for explaining a data management apparatus according to an embodiment of the present invention.

A database management apparatus 1 according to the embodiment of the present invention performs management of data registered in a plurality of databases 201 to 205. The database management apparatus 1 is connected, in a communicable manner, to a storage section 2 constituted by an HDD and the like which stores the databases 201 to 205. The databases 201 to 205 constitute a relational database. The storage section 2 stores a MAIN table 206, a SUB table 207, and a WORK table 208. The databases 201 to 205, MAIN table 206, SUB table 207, and WORK table 208 are not necessarily stored in a single storage section, but may be stored in a plurality of storage sections in a separated manner.

The data management apparatus 1 according to the embodiment of present invention includes a data registration section 101, a data association section 102, a notification section 103, an information generation section 104, a data search section 105, a CPU 106, and a memory 107.

The data registration section 101 has a role of registering data related to a common management target (parts, etc.) in a plurality of different databases.

The data association section 102 has a role of associating first data registered in one of the plurality of databases with second data, the second data being registered in a database other than the database that stores the first data, being related to the same management target with the first data, and having a predetermined correspondence (relation in which one data is derived from the other data) with the first data.

The notification section 103 has a role of performing a predetermined notification to a user having authority to permit or forbid a data registration or update registration when the data registration or update registration is performed by the data registration section 101. In the case where the data registration or update registration performed by the data registration section 101 causes a contradiction in a predetermined correspondence between first data to be newly registered or registered for update with second data, the second data being stored in a database other than the database that the first data is to be registered in and being related to the same management target with the first data, the notification section 103 performs a predetermined notification.

The information generation section 104 has a role of generating information based on data to be newly registered or registered for update when the data registration or update registration is performed by the data registration section 101.

The data search section 105 has a role of searching data that have been registered in the databases 201 to 205.

The CPU 106 has a role of performing various processes in the data management apparatus 1. The CPU 106 also has a role of realizing various functions by executing a program stored in the memory 107. The memory 107 is constituted by a ROM or RAM, and has a role of storing various information and programs utilized in the data management apparatus 1.

In the embodiment of the present invention, the data management apparatus 1 and storage section 2 is connected to each other in a communicable manner through an electrical communication line (the Internet, etc.). The present invention is not limited to this, but the data management apparatus 1 and storage section 2 may be provided in a single apparatus.

The data registration section 101 and data search section 105 are provided outside the data management apparatus 1 and perform processes based on a command or the like send from a PC or the like connected, in a communicable manner, to the data management apparatus 1 through an electrical communication line (the details are described later).

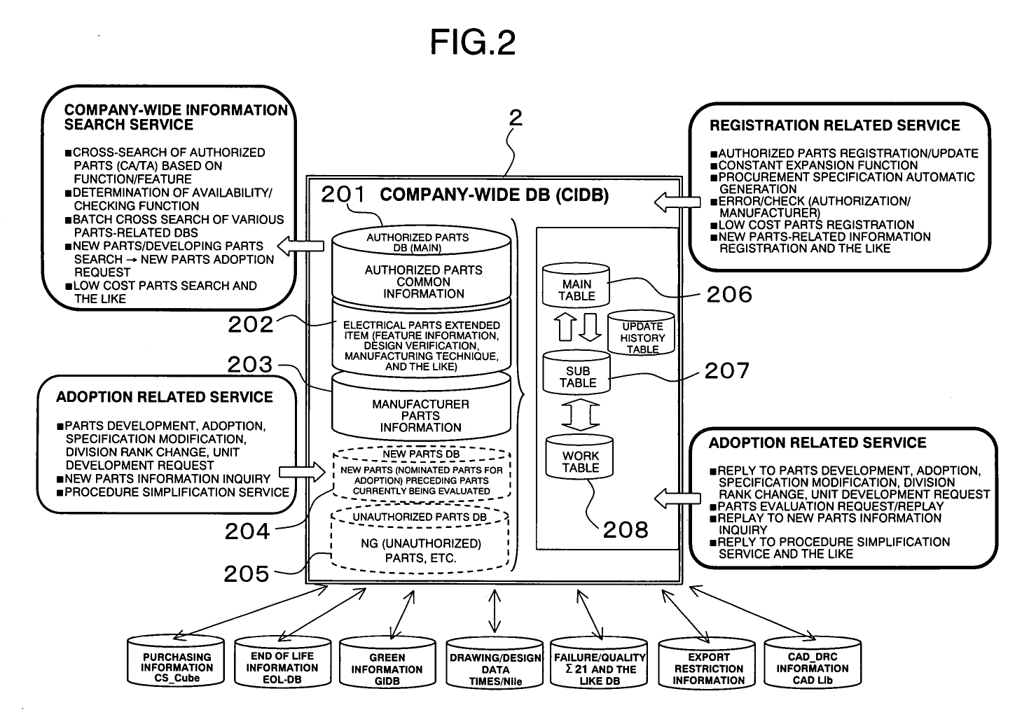

FIG. 2 is a view for explaining an example of management of data registered in databases utilizing the data management apparatus according the embodiment of the present invention. In FIG. 2, information related to parts have been registered in a plurality of databases. In FIG. 2, the same reference numerals as the first embodiment are given to the components which are common to FIG. 1, and the overlapped description is omitted.

The databases 201 to 205, Main table 206, SUB table 207, and WORK table 208 stored in the storage section 2 according to the embodiment are accessible from a client PC and the like connected to the storage section 2 through an electrical communication line such as LAN or the Internet. More concretely, the data registration, data update registration, and data search process for the databases and tables are performed based on a command send from the client PC or the like to the data management apparatus 1 or an input operation for the data management apparatus 1.

The information registered in the databases 201 to 205, MAIN table 206, SUB table 207, and WORK table 208 are used as targets of processing, including a parts information search performed by a user providing a company-wide parts information search service, a registration or change of information related to the parts performed by a user providing a registration related service, and a determination of adoption of the parts or modification of the parts performed by a user providing an adoption related service (performed in cooperation with a supplier). The information registered in the databases and the like are used as targets of processing in a series of processing (for example, parts development, parts adoption determination, authorized parts registration, and the like) which are managed by a workflow. “Authorized parts common information” is common information which is registered in the database 201 and is related to a part to be registered in a plurality of databases. “Electrical parts extended item” is information which is registered in the database 202 and is related to parts features, design verification, manufacturing technique, and the like. “Manufacturer parts information” is registered in the database 203 and indicates the manufacturer of each part. “New parts” is information which is registered in the database 204 and is related to parts nominated for adoption or parts being evaluated. “NG parts, etc.” is information which is registered in the database 205 and is related to parts not authorized by examiners or acknowledgers (to be described later) in an examination (unauthorized parts).

In the embodiment, the storage section 2 also works with a plurality of databases other than the databases 201 to 205. The databases stores purchasing information, End of Life information, green information, design data, information related to failure and quality, information related to export restriction, CAD_ DRC (Design Rule Check) information, and the like.

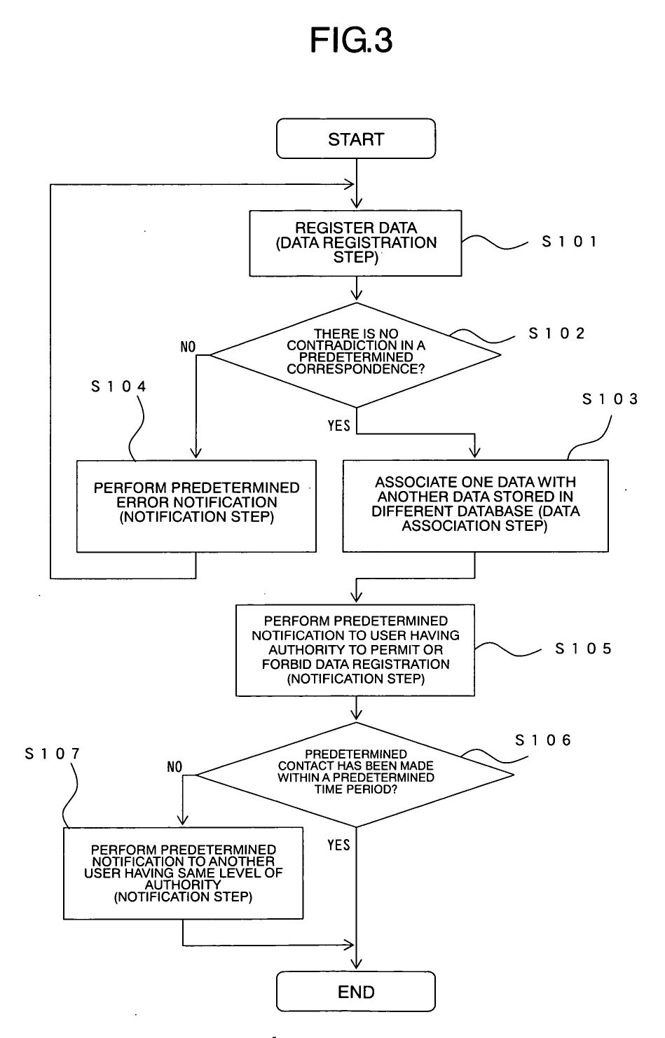

FIG. 3 is a flowchart for explaining the process flow (data management method) in the data management apparatus according to the embodiment of the present invention.

The data registration section 101 registers data in a plurality of different databases for storing data related to a common management target (data registration step) (S101).

The data association section 102 checks whether the data registration or update registration performed in the above step (S101) causes a contradiction in a predetermined correspondence between first data to be newly registered or registered for update with second data stored in a database other than the database that the first data is to be registered in and related to the same management target with the first data (S102).

When a contradiction is found between a predetermined correspondence (No in S102), the notification section 103 performs a notification (a predetermined notification) indicating that the data registration process should be started from the beginning (notification step) (S104) since the registration process causes a contradiction in a predetermined correspondence between the data. In the embodiment of the present invention, the notification by the notification section 103 is displayed in a not-shown display section. The data that has been determined to cause a contradiction in a predetermined correspondence may be registered in a database so as not to become a target of search (for example, a target of parts data selection)

On the other hand, when a contradiction is not found between a predetermined correspondence (Yes in S102), the data association section 102 associates first data, which is the data registered this time, with second data which is stored in a database other than the database that the first data is to be registered in, is related to the same management target with the first data, and has a predetermined correspondence with the first data (data association step) (S103).

The predetermined correspondence indicates a relation in which the content of one data is derived from that of the other data. This means, for example, a relation such as “when the data of some part has been registered in an authorized part (a part adoption of which has been authorized) DB 201, the data of this part could not have been registered in an unauthorized part (a part adoption of which has been unauthorized) DB 205”. As described above, the predetermined correspondence indicates a relation in which the content of one data is inevitably determined by that of the other data.

Subsequently, the notification section 103 performs a notification to a user having authority to permit or forbid a data registration or update registration (S105). At this time, the notification section 103 identifies a user (work flow) having the above authority for each data or each information group including the data and thereby the notification section 103 can notify information related to a change of the contents of the data to adequate persons (examiners or acknowledgers).

When a predetermined answer related to the permission or forbiddance is not returned from the user even after a predetermined time has elapsed since the predetermined notification was performed, the notification section 103 performs the predetermined notification to another user having the same level of authority, if exists (notification step) (S106, S107). As described above, by automatically forwarding the predetermined notification to another user having the same authority when a predetermined answer (contact (a predetermined contact) indicating the result of examination related to the permission or forbiddance) is not returned from the user even after a predetermined time has elapsed since the predetermined notification was performed, it is possible to prevent the workflow from being interrupted by absence of the examiners or acknowledgers.

Here, as described above, the notification section 103 forwards the notification to the user having the same level of authority as the user out of contact. Alternatively, however, the notification section 103 can forward (skip a user out of contact) the notification to a user having the authority to conduct a process (for example, “acknowledgement process” after “examination process”) to be performed next to the process to be performed based on the authority of the user out of contact, thereby increasing processing efficiency in the workflow that performs processes related to data registered in the databases. That is, when a predetermined answer related to the permission or forbiddance is not returned from the user even after a predetermined time has elapsed since the predetermined notification was performed, the notification section 103 performs a predetermined notification to a user having the authority to conduct a process to be performed next to the processing to be performed based on the authority of the user out of contact.

Further, in this embodiment, the notification section 103 sends an E-mail (a predetermined notification) to a predetermined address (specific user such as person in charge, examiner, acknowledger of the registered data) at a predetermined timing (for example, at a timing after a predetermined time period has elapsed since the data registration was performed or at a specific date previously determined) after the data registration or data update registration has been performed as described above (notification step). With the above configuration, when, for example, an acknowledgement process of parts data has not been completed, it is possible to perform a notification indicating that the deadline of the acknowledgement process approaches to a user having the authority to conduct the acknowledgement at a timing such as five days before, or ten days before the deadline, thereby preventing the delay of the work.

When the data registration or data update registration is performed as described above, the information generation section 104 generates information based on the data to be newly registered or registered for update (information generation step).

The above respective steps (S101 to S107) in the data management method is realized by allowing the CPU (computer) 106 to execute a data management program stored in the memory 107.

The data registration process and data update process for the databases performed utilizing the data management apparatus according to the embodiment of the present invention will next be described.

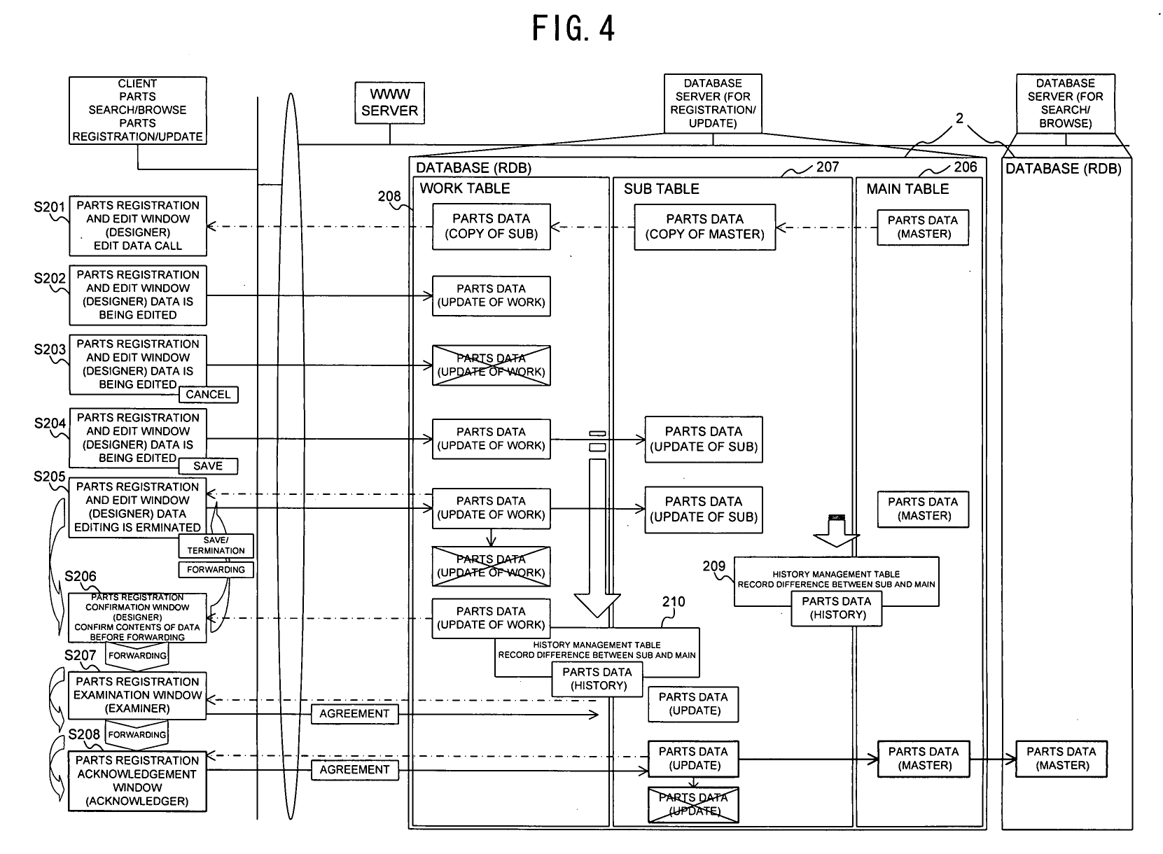

FIG. 4 is a view for explaining the flow of the data registration process and data update process for the databases. The MAIN table 206 is a final storage table which is the most important table for managing data; the SUB table 207 is a storage table, which is obtained by coping the MAIN table 206, for the data in the middle of an update process and stores data by an explicit action of a user; and the WORK table 208, which is obtained by coping the SUB table 207, temporarily stores and manages the data being subjected to GUI operation. The MAIN table 206 stores the same data as the databases 201 to 205 which is a target of browsing through the data search section and the like.

A history management table 209 is a table for managing a change history that manages a difference between the SUB table 207 and MAIN table 206. A history management table 210 is a table for managing a change history that manages a difference between the WORK table 208 and SUB table 207.

When the data management apparatus 1 receives a change request (command) of the contents related to target data from a PC or the like provided outside of the data management apparatus 1 and connected to the data management apparatus 1 in a communicable manner through a WWW server, database server, or the like, the target data is copied from the MAIN table 206 to SUB table 207. Further, the target data is copied from the SUB table 207 to WORK table 208. The notification section 103 allows the PC or the like (hereinafter, referred to as “client”) outside the data management apparatus 1 to display the data copied to the WORK table 208 (S201).

When an action that can be detected by a WWW server side is generated while a user is executing data editing (data input, window shift operation, or the like) on the client, the data registration section 101 allows the WORK table 208 (update of WORK) to store the data on the current working window and, at the same time, allows the history management table 210 to store a difference between the WORK table 208 (update of WORK) and SUB table 207 (S202).

When a cancel process is performed without explicitly storing the editing data while the user is executing data editing on the client, the parts data in the WORK table 208 is deleted; whereas an access is not made to the SUB table 207 (S203).

When the user performs an operation (for example, a click of a store button) of temporarily storing the editing data during the data editing, the data registration section 101 performs an update process of the WORK table 208 and allows the history management table 210 to record the difference between the WORK table 208 and SUB table 207. The data registration section 101 then allows the history management table 210 to store the update contents in the SUB table 207 (S204).

When the user performs an operation (for example, a click of a save/termination or termination button) of terminating an application after the completion of the data editing, the data registration section 101 performs an update process of the WORK table 208 and allows the history management table 210 to record the difference between the WORK table 208 and SUB table 207. The data registration section 101 then allows the history management table 210 to store the update contents in the SUB table 207. Further, the data registration section 101 allows the history management table 209 to record the difference between the SUB table 207 and MAIN table 206 (S205).

Assume that the data editing is performed again after occurrence of operational trouble in the client or network failure. In this case, if target data exists in the WORK table 208 at the time when the client designates the data to be changed, the notification section 103 inquires the user whether to continue the work using the data in the WORK table 208 through the display window on the client. When the user determines to continue the work, the notification section allows the client to display the contents of the data in the WORK table 208.

When the information related to the contents of the edited data is forwarded (according to the workflow) to an examiner who examines the validity and the like of the contents thereof after completion of the data editing process on the client, the notification section 103 allows the client (including PC of the examiner) to display the data from the WORK table 208 (S206). When the flow returns to S205, the same operation is performed. The data registration section 101 deletes the target data in the WORK table 208 after the data forwarding has been completed.

When the above examination process of the edited data is performed on the client (PC of the examiner), the examiner allows the information stored in the SUB table 207 to be displayed and confirms the change through the history management table 209 (S207).

When an acknowledgement process of the edited data is performed on the client (PC of the acknowledger) after the completion of the examination process, the acknowledger allows the information stored in the SUB table 207 to be displayed on the client and confirms the change through the history management table 209. When the change is acknowledged by the confirmation, the data registration section 101 uses the history management table 209 to store the change in the MAIN table 206. After the completion of the storage of the change, the data registration section 101 deletes the data temporarily stored in the SUB table 207 (S208). After that, the data registration section 101 copies the changed (updated) parts data to a search/browse DB server.

Although, in FIG. 4, the databases (MAIN table 206, SUB table 207, WORK table 208, and the like) used for the data registration or data update and the database for which the client performs a search or browse process are stored in the same storage section 2, they may be stored in different databases (database servers).

As described above, in the embodiment of the present invention, only when the person having a predetermined authority for each data gives authorization, the data is allowed to be registered in the database for which the client performs a search or browse process. This configuration prevents the data that has not undergone the acknowledgement process by the acknowledger from being erroneously disclosed.

When the data registration or update registration is performed by the data registration section 101 as described above, the information generation section 104 in the present embodiment automatically generates, for example, an electronic form such as an electronic answer sheet or electronic drawing based on the data to be newly registered or registered for update.

More specifically, when a work completion date is input (registered) in the item of scheduled date previously set in the database, the information generation section 104 automatically generates data related to “work completion notification”. Further, when a series of electronic parts, such as a resistor or condenser, is registered by the data registered section 101, the information generation section 104 acquires information related to the minimum, maximum, and standard value (for example, E24 or E48) of the constant number of the electronic parts to thereby automatically generate parts information for each individual part (for each type name) of the electronic parts series. As a matter of course, when the automatically generated parts information and the like is registered in the databases, the workflow that performs the above examination and acknowledgment processes is automatically started, increasing effectiveness of the data registration or data update performed for the databases.

The information generated as described above by the information generation section 104 is send to a predetermined address (abovementioned examiner or acknowledger) by the notification section 103.

Further, in the present embodiment, process histories (change history, and the like) of data registration or data update process performed for the databases are stored in the storage section 2 as an update history table (history management table). As a result, even if there occurs a system trouble or the like during the data registration process, original data can reliably be restored. Further, even if there is an error in the registration/update process, it is possible to easily and reliably correct the error.

Further, in the present embodiment, in the case where a process related to the data registered in a plurality of databases is performed according to a plurality of workflows, a configuration in which a process in one workflow is started in succession to the completion of a process in any other workflow is possible. This is realized by a notification process of the notification section 103. More specifically, when a data registration process (for example, registration indicating the denial of the registration of some data) has been completed according to one workflow, the notification section 103 performs a notification to the user having the authority to conduct a process in another workflow. With the above configuration, it is possible to realize an interactive communication between a plurality of different workflows. For example, it is possible to transmit work schedule information created by a user belonging to a department that undertakes the work to a user belonging to a department that requests the work, as well as to transmit the information indicating the acknowledgement or denial of the work schedule in the opposite direction.

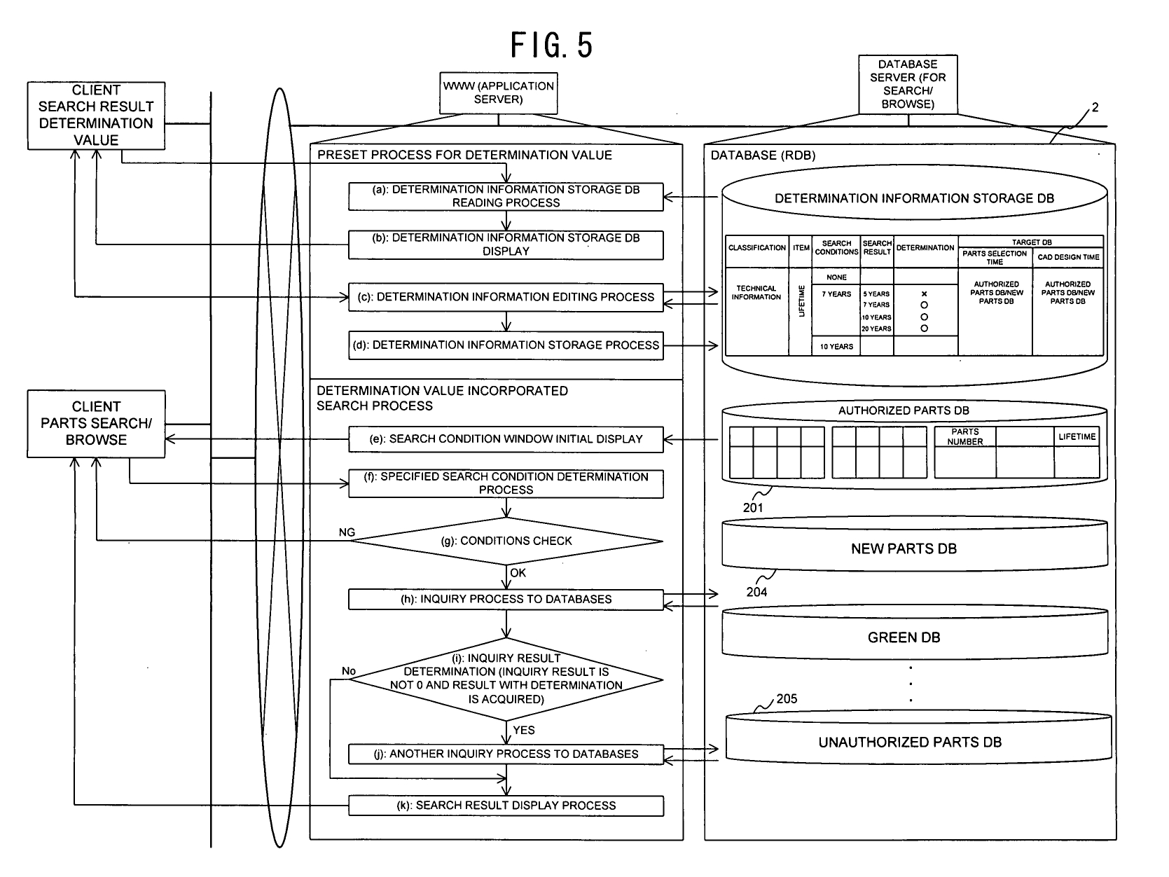

FIG. 5 is a view for explaining a search process for data registered in the databases 201 to 205 in the data management apparatus according to the embodiment of the present invention. The right side of FIG. 5 shows the data contents in the databases stored in the storage section 2, and the center thereof shows the flow of the processes (a) to (k) in the WWW server.

When a command to display determination values used in the search of the data registered in the databases 201 to 205 is issued from the client, determination information (refer to determination information storage DB of FIG. 5) used in a database search is acquired from a determination information storage DB stored in the storage section 2 (a).

Subsequently, the acquired determination information is displayed on the client (b). After the completion of an edit process (c) for the determination information on the client, the edited determination information is stored in the determination information storage DB registered in the database (d).

A database search process that the client performs using the determination information will next be described. Firstly, a window prompting a user to input search conditions is displayed on the client (e). After the search conditions are specified, determination based on the specified search conditions is made (f).

Subsequently, the search conditions subjected to the determination process are checked (g). When there is no problem in the contents of the search conditions, inquiry with the search conditions is made to the databases (h). When the result of the inquiry is not 0 and a determination process of the result is performed, another inquiry to the databases is performed ((i), (j)). In the case where the inquiry process (i) is not performed, or when the another inquiry to the databases has been completed (j), a result of the search is displayed (k). With the processes (a) to (k), the search process of the data registered in the databases is performed from the client side.

Although the notification of the notification section 103 is displayed on a not-shown display section or on the client PC in the above embodiment, the information to be notified may be printed out or stored in a database.

When the above described data management program is stored in a computer-readable storage medium (for example, memory 107), a computer constituting the data management apparatus can execute the program. The computer-readable storage medium mentioned here includes: portable storage medium such as a CD-ROM, a flexible disk, a DVD disk, a magneto-optical disk, a semiconductor storage device such as an IC card; a fixed memory device such as an ROM or RAM mounted in a computer, or a magnetic recording device; a database that holds computer program; another computer and database thereof; and a transmission medium on a network line.

What is claimed is:

1. A data management apparatus comprising:
a data registration section that registers data in a plurality of different databases storing data related to a common management target; and
a data association section that associates first data registered in one of the plurality of databases with second data, the second data being registered in a database other than the database that stores the first data, being related to the same management target with the first data, and having a predetermined correspondence with the first data, wherein
the predetermined correspondence is a relation in which one data is derived from the other data.

2. The data management apparatus according to claim 1, comprising a notification section that performs a predetermined notification to a user having authority to permit or forbid a data registration or update registration when the data registration or update registration is performed by the data registration section,
when a predetermined answer related to the permission or forbiddance is not returned from a first user even after a predetermined time has elapsed since the predetermined notification was performed, the notification section performing the predetermined notification to a second user having the same level of authority or having the authority to conduct a process to be performed next to the process to be performed based on the authority of the first user, if exists.

3. The data management apparatus according to claim 1, wherein
the notification section performs a predetermined notification to a predetermined address at a predetermined timing after the data registration or data update registration has been performed by the data registration section.

4. The data management apparatus according to claim 1, comprising an information generation section that generates information based on data to be newly registered or registered for update when the data registration or update registration is performed by the data registration section.

5. The data management apparatus according to claim 1, wherein
the notification section performs a predetermined notification in the case where data registration or update registration performed by the data registration section causes a contradiction in a predetermined correspondence between first data to be newly registered or registered for update with second data, the second data being stored in a database other than the database that the first data is to be registered in and being related to the same management target with the first data.

6. The data management apparatus according to claim 1, wherein the plurality of databases constitute a relational database.

7. A data management method comprising:
a data registration step that registers data in a plurality of different databases storing data related to a common management target; and
a data association step that associates first data registered in one of the plurality of databases with second data, the second data being registered in a database other than the database that stores the first data, being related to the same management target with the first data, and having a predetermined correspondence with the first data, wherein
the predetermined correspondence is a relation in which one data is derived from the other data.

8. The data management method according to claim 7, comprising a notification step that performs a predetermined notification to a user having authority to permit or forbid a data registration or update registration when the data registration or update registration is performed in the data registration step,
when a predetermined answer related to the permission or forbiddance is not returned from a first user even after a predetermined time has elapsed since the predetermined notification was performed, the notification step performing the predetermined notification to a second user having the same level of authority or having the authority to conduct a process to be performed next to the process to be performed based on the authority of the first user, if exists.

9. The data management method according to claim 7, wherein
the notification step performs a predetermined notification to a predetermined address at a predetermined timing after the data registration or data update registration has been performed in the data registration step.

10. The data management method according to claim 7, comprising an information generation step that generates information based on data to be newly registered or registered for update when the data registration or update registration is performed in the data registration step.

11. The data management method according to claim 7, wherein
the notification step performs a predetermined notification in the case where data registration or update registration performed in the data registration step causes a contradiction in a predetermined correspondence between first data to be newly registered or registered for update with second data, the second data being stored in a database other than the database that the first data is to be registered in and being related to the same management target with the first data.

12. The data management method according to claim 7, wherein the plurality of databases constitute a relational database.

13. A data management program allowing a computer to execute:
a data registration step that registers data in a plurality of different databases storing data related to a common management target; and
a data association step that associates first data registered in one of the plurality of databases with second data, the second data being registered in a database other than the database that stores the first data, being related to the same management target with the first data, and having a predetermined correspondence with the first data, wherein
the predetermined correspondence is a relation in which one data is derived from the other data.

14. The data management program according to claim 13, comprising a notification step that performs a predetermined notification to a user having authority to permit or forbid a data registration or update registration when the data registration or update registration is performed in the data registration step,
when a predetermined answer related to the permission or forbiddance is not returned from a first user even after a predetermined time has elapsed since the predetermined notification was performed, the notification step performing the predetermined notification to a second user having the same level of authority or having the authority to conduct a process to be performed next to the process to be performed based on the authority of the first user, if exists.

15. The data management program according to claim 13, wherein
the notification step performs a predetermined notification to a predetermined address at a predetermined timing after the data registration or data update registration has been performed in the data registration step.

16. The data management program according to claim 13, comprising an information generation step that generates information based on data to be newly registered or registered for update when the data registration or update registration is performed in the data registration step.

17. The data management program according to claim 13, wherein
the notification step performs a predetermined notification in the case where data registration or update registration performed in the data registration step causes a contradiction in a predetermined correspondence between first data to be newly registered or registered for update with second data, the second data being stored in a database other than the database that the first data is to be registered in and being related to the same management target with the first data.

18. The data management program according to claim 13, wherein the plurality of databases constitute a relational database.
